(19) United States
(12) Patent Application Publication
(10) Pub. No.: US 2008/0138552 A1
(43) Pub. Date: Jun. 12, 2008

(54) Colorful air cushion structure

(76) Inventor: Swei Mu Wang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/637,180

(22) Filed: Dec. 12, 2006

(51) Int. Cl. A47C 27/14; B32B 27/20

(52) U.S. Cl. 428/36.5; 428/35.7

(57) ABSTRACT

A colorful air cushion is made of transparent thermoplastic material, and it is a hollow structure that can create a three-dimensional and colorful decorative effect. At appropriate portions of the inner surface of an air chamber of the air cushion are laminated with color films for forming the background color of the air cushion, thereby creating a three-dimensional effect and showing the variation of color components so as to greatly enhance a colorful decorative effect and a visual interest, when the light penetrates the wall thickness of the air cushion.

### BACKGROUND OF THE INVENTION

1. Field of the Invention

The present invention relates to a colorful air cushion structure that is interiorly provided with color films so as to greatly enhance a colorful decorative effect thereof.

2. Description of the Prior Arts

In general, air cushions which are made of thermoplastic material, such as polyurethane, are widely used on the fillings of sport equipments, for example, the insoles of sport shoes or kneepads and the like, are applied for the shock-absorbing purpose thereof, thus achieving the prevention of sports injury.

Taiwan Patent Publication No. 313549, entitled “Manufacturing Method of Air Sac”, discloses that a conventional air cushion is made of thermoplastic material and has the property of transparency, unfortunately, such an air cushion doesn't have the property of changing three-dimensional color, hence it is difficult to draw people's attention by the color appearance.

The present invention has arisen to mitigate and/or obviate the afore-described disadvantages.

### SUMMARY OF THE INVENTION

The primary objective of the present invention is to provide a colorful air cushion structure, the inner top and bottom surfaces of an air chamber of which are laminated with color films so as to create a three-dimensional effect and show the variation of color components for making the air cushion eye appealing, when the light penetrates the wall thickness of the air cushion.

The present invention will become more obvious from the following description when taken in connection with the accompanying drawings, which show, for purpose of illustrations only, a preferred embodiment in accordance with the present invention.

### BRIEF DESCRIPTION OF THE DRAWINGS

FIG. 1 is an exploded view of a colorful air cushion structure in accordance with the present invention;

FIG. 2 is a perspective view of the colorful air cushion structure in accordance with the present invention;

FIG. 3 is a top plan view of the colorful air cushion structure in accordance with the present invention;

FIG. 4 is an assembly cross-sectional view of the colorful air cushion structure in accordance with the present invention;

FIG. 5 is an enlarged view of a part of FIG. 4.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

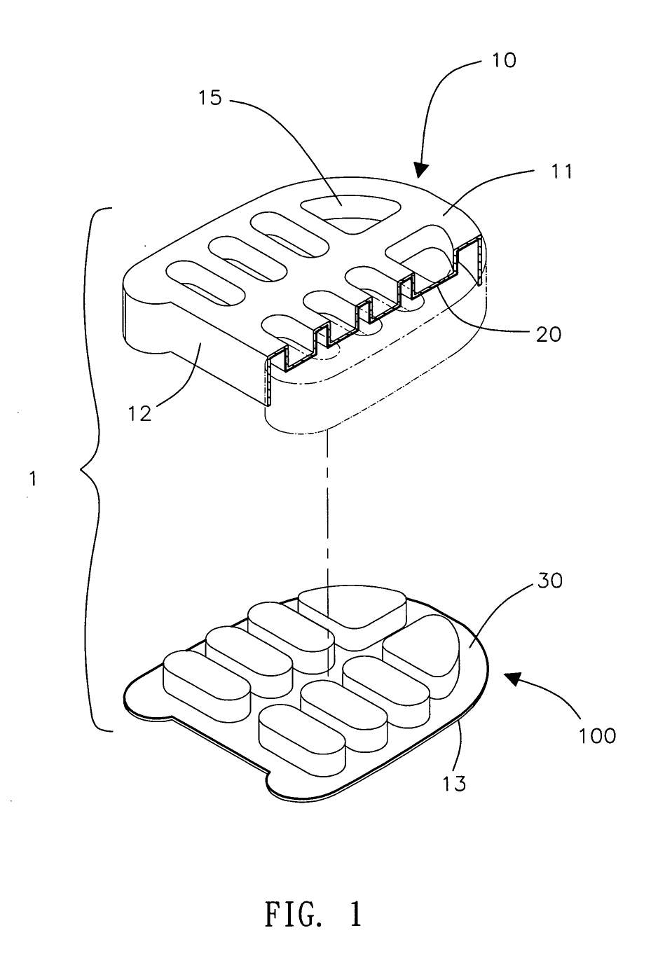

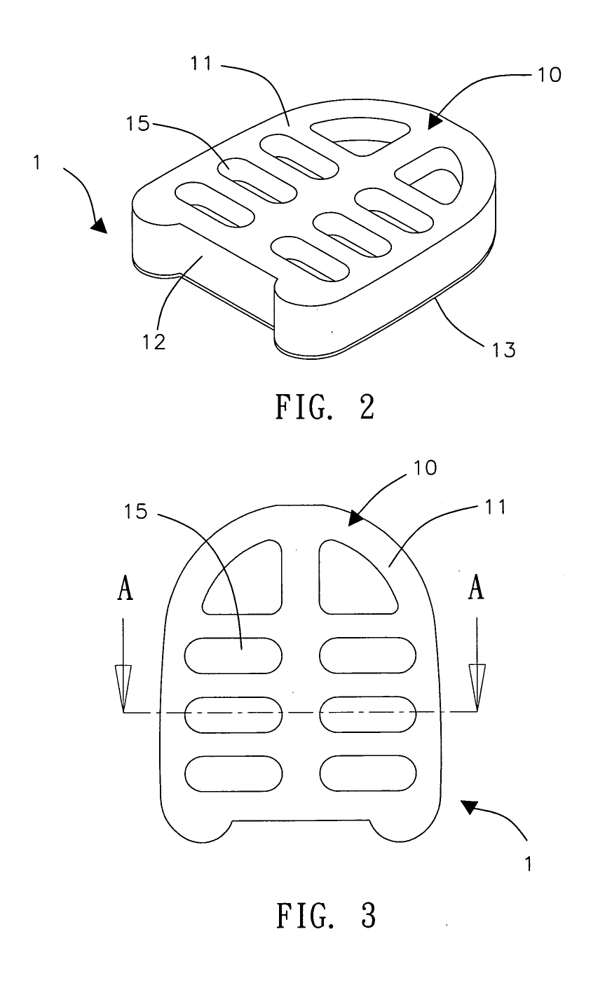

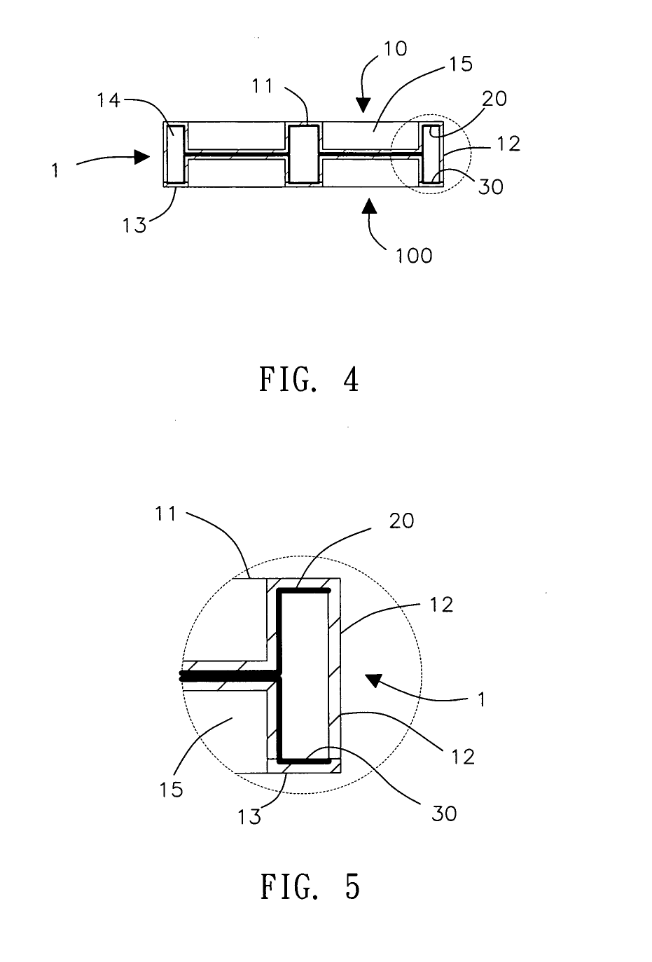

Referring to FIGS. 1-5, an air cushion 1 in accordance with the present invention comprises a main shell 10 and a sub-shell 100 that are made of thermoplastic transparent material and formed by thermo forming, vacuum forming, or blow forming process.

The main shell 10 is provided with a top surface 11 and a side surface 12 extending downwardly from the periphery of the top surface 11. The sub-shell 100 includes a bottom 13 formed symmetrically relative to the top surface 11, and the side surface 12 of the main shell 10 is tightly connected to the periphery of the sub-shell 100, so as to define an air chamber 14 between the main shell 10 and the sub-shell 100, thus forming the basic structure of the air cushion 1 of the present invention. The air chamber 14 can be filled with gel, fluid, foaming material, or pressurized air.

At specific positions of the top surface 11 relative to the bottom 13 are formed a plurality of concaves 15 that are connected to each other, so as to improve the structural strength of the air cushion 1.

The present invention is characterized as follows:

In the step of forming the main shell 10, the opposite side of the top surface 11 is laminated with a color film 20, and in the step of forming the sub-shell 100, the opposite side of the bottom 13 is laminated with a color film 30 as well so that the inner top and bottom surfaces of the air chamber 14 are laminated with color films 20 and 30 after the air cushion 1 is finished, thus forming the background color of the top surface 11 and the bottom 13 of the air cushion 1. The side surface 12 of the air cushion 1 is formed with a transparent area, and the color films 20 and 30 are attached to the inner surface of the concaves 15, creating a three-dimensional effect. By such arrangements, when the light penetrates the wall thickness of the air cushion 1 and the transparent area of the side surface 12, the air cushion 1 looked extremely beautiful against the color films 20 and 30, thus creating a three-dimensional effect and showing the variation of color components. Such a technical innovation substantially improves the visual interest, making the air cushion eye appealing. For example, the air cushion 1 is provided with black films 20 and 30 so as to define a semi-transparent or opaque area on the top surface 11, the bottom 13 and the concaves 15 of the air cushion 1, and plus the transparent area of the side surface 12, it can create a three-dimensional and colorful decorative effect.

The color film 20 or 30 can be a pattern film, a laser film, or an electroplating film, as long as it can create a three-dimensional and colorful decorative effect.

To sum up, the advantages of the present invention are listed as follows:

1. Having various changeable colors: because the colors of the air cushion of the present invention depend on the color films 20 and 30, any desired color can be formed onto the air cushion so as to show a superior visual effect, thereby enhancing the additional value of the air cushion. Moreover, due to the color films 20 and 30 are disposed in the air chamber 14, hence a color fading question resulted from friction will be avoidable.

2. Reducing the production cost: in the manufacturing process, because the color films 20 and 30 are disposed on the inner surfaces of the main shell 10 and the sub-shell 100 in an automatized manner, thus allowing the mass production so as to diminish the production cost.

3. Non-limiting the manufacturing shape of the air cushion: due to the shape of the air cushion of the present invention is formed based on the shapes of the mold cavity and the mold base, the random curvature and structural variation can both be obtained.

4. Merely increasing a little weight: the air cushion of the present invention is only additionally provided with the color films therein, thus merely increasing a little weight of it.

While we have shown and described various embodiments in accordance with the present invention, it should be clear to those skilled in the art that further embodiments may be made without departing from the scope of the present invention.

What is claimed is:

1. A colorful air cushion structure being made of transparent thermoplastic material, in said air cushion structure being formed an air chamber, and an inner surface of said air chamber being laminated with a color film.

2. A colorful air cushion structure being made of transparent thermoplastic material and comprising a main shell and a sub-shell;
said main shell formed with a top surface and a side surface extending downwardly from a periphery of said top surface, said sub-shell having a bottom formed symmetrically relative to said top surface, and said side surface of said main shell being tightly connected to a periphery of said sub-shell so as to define an air chamber between said main shell and said sub-shell;
a plurality of concaves being formed in said top surface and said bottom of said air cushion and being connected to each other,
inner surfaces of said respective concaves being laminated with color films.

3. The colorful air cushion structure as claimed in claim 2, wherein an inner top surface and a bottom surface of said air chamber are laminated with color films, thus forming a background color of said top surface and said bottom of said air cushion.

4. The colorful air cushion structure as claimed in claim 1, wherein said air chamber is filled with gel or fluid.

5. The colorful air cushion structure as claimed in claim 2, wherein said air chamber is filled with gel or fluid

6. The colorful air cushion structure as claimed in claim 1, wherein said air chamber is filled with foaming material.

7. The colorful air cushion structure as claimed in claim 2, wherein said air chamber is filled with foaming material.

8. The colorful air cushion structure as claimed in claim 1, wherein said air chamber is filled with flowing medium.

9. The colorful air cushion structure as claimed in claim 2, wherein said air chamber is filled with flowing medium.

10. The colorful air cushion structure as claimed in claim 1, wherein said color film is a pattern film.

11. The colorful air cushion structure as claimed in claim 2, wherein said color film is a pattern film.

12. The colorful air cushion structure as claimed in claim 1, wherein said color film is a laser film.

13. The colorful air cushion structure as claimed in claim 2, wherein said color film is a laser film.

14. The colorful air cushion structure as claimed in claim 1, wherein said color film is an electroplating film.

15. The colorful air cushion structure as claimed in claim 2, wherein said color film is an electroplating film.
